(19) United States
(12) Patent Application Publication
(10) Pub. No.: US 2014/0174736 A1
(43) Pub. Date: Jun. 26, 2014

(54) Wellbore Servicing Materials and Methods of Making and Using Same

(71) Applicant: HALLIBURTON ENERGY SERVICES, INC., Houston, TX (US)

(72) Inventors: B. Raghava REDDY, The Woodlands, TX (US); Wirdansyah LUBIS, Magnolia, TX (US); Hsin-Chen CHUNG, Houston, TX (US); Natalie Lynn PASCARELLA, Houston, TX (US)

(73) Assignee: HALLIBURTON ENERGY SERVICES, INC., Houston, TX (US)

(21) Appl. No.: 13/724,549

(22) Filed: Dec. 21, 2012

(51) Int. Cl. C09K 8/42; E21B 43/26

(52) U.S. Cl. CPC C09K 8/426; E21B 43/261
USPC 166/281; 507/242; 548/518

(57) ABSTRACT

A method of servicing a wellbore in a subterranean formation comprising placing a composition comprising a carrier fluid and a degradable polymer into the subterranean formation wherein the degradable polymer comprises polyimide, allowing the degradable polymer to form a diverter plug at a first location in the wellbore or subterranean formation, diverting the flow of a wellbore servicing fluid to a second location in the wellbore or subterranean formation that is different than the first location; and removing all or a portion of the diverter plug by contacting the diverter plug with a degradation accelerator wherein the degradation accelerator comprises an amino alcohol, an amino alcohol precursor, an organic amine, an organic amine precursor or combinations thereof. A wellbore servicing fluid comprising polysuccinimide wherein the wellbores servicing fluid has a pH of less than about 7.

### CROSS-REFERENCE TO RELATED APPLICATIONS

Not applicable.

### STATEMENT REGARDING FEDERALLY SPONSORED RESEARCH OR DEVELOPMENT

Not applicable.

### BACKGROUND

1. Field

This disclosure relates to methods of servicing a wellbore. More specifically, it relates to servicing a wellbore with degradable particulate diverting and fluid loss control agents in combination with degradation accelerators.

2. Background

Natural resources (e.g., oil or gas) residing in the subterranean formation may be recovered by driving resources from the formation into the wellbore using, for example, a pressure gradient that exists between the formation and the wellbore, the force of gravity, displacement of the resources from the formation using a pump or the force of another fluid injected into the well or an adjacent well. The production of fluid in the formation may be increased by hydraulically fracturing the formation. That is, a viscous fracturing fluid may be pumped down the wellbore at a rate and a pressure sufficient to form fractures that extend into the formation, providing additional pathways through which the oil or gas can flow to the well.

Unfortunately, water rather than oil or gas may eventually be produced by the formation through the fractures therein. To provide for the production of more oil or gas, a fracturing fluid may again be pumped into the formation to form additional fractures therein. However, the previously used fractures first must be plugged to prevent the loss of the fracturing fluid into the formation via those fractures. In some instances, some fractures, natural or induced, may take in most of proppant used in propping the created fracture open leaving less than optimum amount of proppant for other fractures. A proppant diversion technique would enable even distribution of the proppant into all the fractures thereby increasing the exposed fracture area to hydrocarbon flow. Diversion of fracturing fluids in shale zones during fracturing process is also helpful in increasing the complexity of fracture geometry by branching of the fractures in multiple directions thereby exposing a greater portion of the geological formation to fluid flow.

Diversion of fluids is also important in removing near wellbore damage to formation permeability due to variety of reasons, for example scale deposition, hydrocarbon deposition the like. The cleanup fluids used in removing such damage include acidic fluids or surfactant-based fluids. In order to evenly disperse the cleanup fluids over the entire damaged area, diverting agents may be used to divert the fluids to undertreated zones.

Diverting materials are typically introduced into the wellbore and surrounding formation as temporary plugs that are disposed within high-permeability zones during various wellbore servicing operations such as fracturing, completion, clean-up, and acidizing treatment operations. While the diverter plugs are in place, the formation may be subjected to the wellbore servicing operations that are meant to increase the well productivity. Subsequent to the wellbore servicing operation, the diverting material may be degraded and removed to restore the formation permeability. An ongoing need exists for diverting materials that provide temporary plugs that are stable to a variety of wellbore servicing fluids and are able to be degraded in some user and/or process desired time frame.

### SUMMARY

Disclosed herein is a method of servicing a wellbore in a subterranean formation comprising placing a composition comprising a carrier fluid and a degradable polymer into the subterranean formation wherein the degradable polymer comprises polyimide, allowing the degradable polymer to form a diverter plug at a first location in the wellbore or subterranean formation; diverting the flow of a wellbore servicing fluid to a second location in the wellbore or subterranean formation that is different than the first location; and removing all or a portion of the diverter plug by contacting the diverter plug with a degradation accelerator wherein the degradation accelerator comprises an amino alcohol, an amino alcohol precursor, an organic amine, an organic amine precursor or combinations thereof.

Also disclosed herein is a wellbore servicing fluid comprising polysuccinimide wherein the wellbores servicing fluid has a pH of less than about 7.

Also disclosed herein is a method of servicing a wellbore in a subterranean formation comprising placing a first quantity of a fracturing fluid, an acidizing fluid, or both at a first location in the subterranean formation placing a polyimide-laden fluid at the first location in the subterranean formation to form a diverter plug placing a second quantity of fracturing fluid, acidizing fluid, or both at a second location in the subterranean formation, wherein the diverter plug diverts the second quantity from the first location to the second location; and removing all or a portion of the diverter plug by contacting the diverter plug with a degradation accelerator wherein the degradation accelerator comprises an amino alcohol, an amino alcohol precursor or combinations thereof.

Also disclosed herein is a method of servicing a wellbore in a subterranean formation comprising placing a composition comprising a carrier fluid and a degradable polymer into the subterranean formation wherein the degradable polymer comprises a polyimide, and a phase transfer catalyst; allowing the degradable polymer to form a diverter plug at a first location in the wellbore or subterranean formation; diverting the flow of a wellbore servicing fluid to a second location in the wellbore or subterranean formation that is different than the first location; and removing all or a portion of the diverter plug by contacting the diverter plug with a degradation accelerator wherein the degradation accelerator comprises an inorganic base or base precursor.

Also disclosed herein is a method of servicing a wellbore in a subterranean formation comprising placing a first quantity of a fracturing fluid, an acidizing fluid, or both at a first location in the subterranean formation placing a polyimide-laden fluid comprising an amino alcohol, an amino alcohol precursor, an organic amine, an organic amine precursor or any combination thereof at the first location in the subterranean formation to form a diverter plug placing a second quantity of an acidic wellbore servicing fluid at a second location in the subterranean formation, wherein the diverter plug diverts the second quantity from the first location to the second location; an removing all or a portion of the diverter plug by placing the well on production and allowing the flow back fluid comprising a spent acidic wellbore servicing fluid.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the conception and the specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 displays the results of a static fluid loss test in the absence and in the presence of polysuccinimide.

FIG. 2 displays the results of a cumulative static fluid loss as a function of time for polysuccinimide under acidic conditions.

FIG. 3 displays the results of a normalized static fluid loss as a function of square root of time for polysuccinimide under acidic conditions.

FIG. 4 displays pictures of filtercake at different polysuccinimide loadings and filtercake removal with a degradation accelerator as described in Example 3.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques below, including the exemplary designs and implementations illustrated and described herein, but may be modified within the scope of the appended claims along with their full scope of equivalents.

Disclosed herein are diverter materials (DMs) comprising a degradable material which may also function as fluid loss agents. The DM may be characterized as a particulate material that can function to form a temporary plug in a high-permeability zone that facilitates a wellbore servicing operation (e.g., fracturing, acidizing). In an embodiment, the DM is a degradable polymer, for example a degradable polyimide polymer. In an embodiment, the DM is resistant to acid-degradation. The DM may be placed downhole by combining the DM with a carrier fluid to form a DM-laden fluid. In an embodiment, the DM is used in combination with a degradation accelerator (DA) to control degradation rate of the DM. In an embodiment, the DM-laden fluid comprises a DA. These and other aspects of DMs comprising a polyimide are described in greater detail herein.

In an embodiment, the DM comprises a degradable material that may undergo irreversible degradation downhole. As used herein “degradation” refers to the separation of the material into simpler compounds that do not retain all the characteristics of the starting material. The terms “degradation” or “degradable” may refer to either or both of heterogeneous degradation (or bulk erosion) and/or homogeneous degradation (or surface erosion), and/or to any stage of degradation in between these two. Not intending to be bound by theory, degradation may be a result of, inter alia, an external stimuli (e.g., heat, temperature, pH, etc.). As used herein, the term “irreversible” means that the degradable material, once degraded downhole, should not recrystallize, reform, reconstitute or, reconsolidate while downhole. In an embodiment, the DM comprises a naturally-occurring material (for example, a naturally-occurring monomer in the degradable polymer). Alternatively, the DM comprises a synthetic degradable material. Alternatively, the DM comprises a mixture of a naturally-occurring and synthetic degradable material. Alternately, the DM is biodegradable where biodegradable refers to the ability of a material to be decomposed by a living organism.

In an embodiment, the DM comprises a degradable material suitable for distribution within or into a flowpath (e.g., a subterranean flowpath within a wellbore and/or surrounding formation), for example, so as to form a pack, a bridge, a plug or a filter cake and thereby obstruct fluid movement via that flowpath.

In an embodiment the DM comprises a degradable polymer. Herein the disclosure may refer to a polymer and/or a polymeric material. It is to be understood that the terms polymer and/or polymeric material herein are used interchangeably and are meant to each refer to compositions comprising at least one polymerized monomer in the presence or absence of other additives traditionally included in such materials. Examples of degradable polymers suitable for use as the DM include, but are not limited to homopolymers, random, block, graft, star- and hyper-branched aliphatic polyesters, copolymers thereof, derivatives thereof, or combinations thereof. The term “derivative” is defined herein to include any compound that is made from one or more of the diverting materials, for example, by replacing one atom in the diverting material with another atom or group of atoms, rearranging two or more atoms in the diverting material, ionizing one of the diverting materials, or creating a salt of one of the diverting materials. The term “copolymer” as used herein is not limited to the combination of two polymers (e.g., a polymer formed from two or more different types of monomers), but includes any combination of any number of polymers, e.g., graft polymers, terpolymers and the like.

In an embodiment, the degradable polymer comprises imide functional groups in the polymer backbone. The structure of an imide functional group is shown in Formula I below:

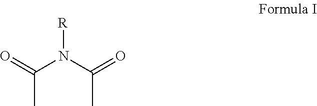

where R is hydrogen, an alkyl group, an aryl group or an arylalkyl group. Examples of degradable polymers comprising imide groups, collectively referred to hereafter as polyimides include without limitation polyimide homopolymers, polyamido-imides, and polyesterimides. In an embodiment, the degradable polymer comprises a polyimide (e.g., a degradable polyimide polymer). For example the degradable polymer (e.g., degradable polyimide polymer) may comprise a polyimide such as polysuccinimide, polymaleimide, polyglutimide, copolymers, blends, derivatives, or combinations thereof.

In an embodiment, the degradable polymer comprises a polyamidoimide. Examples of polyamidoimides comprising amide and imide functional groups suitable for use in the present disclosure include without limitation those obtained by condensation polymerization of diamines (for example, 4,4′-oxydianiline) and a dianhydride (for example, pyromellitic dianhydride) or an anhydride-acid chloride (for example, trimellitic anhydride acid chloride). Such polymers are described in U.S. Pat. No. 5,010,167 which is incorporated by reference herein in its entirety. An example of a commercially available polyamido-imide suitable for use in the present disclosure is TORLON manufactured by Solvay Group, Brussels, Belgium.

In an embodiment the degradable polymer is a polyesterimide. Examples of polyesterimide polymers suitable for use in the present disclosure include without limitation the polymers prepared from trimellitic anhydride with diamines and diol combinations. Such polymers are described in U.S. Pat. Nos. 3,274,159; 4,687,834; and 6,740,728 each of which are incorporated by reference herein in their entirety.

The physical properties associated with the degradable polymer may depend upon several factors including, but not limited to, the composition of the repeating units, flexibility of the polymer chain, the presence or absence of polar groups, polymer molecular mass, the degree of branching, polymer crystallinity, polymer orientation, or the like. For example, a polymer having substantial short chain branching may exhibit reduced crystallinity while a polymer having substantial long chain branching may exhibit for example, a lower melt viscosity and impart, inter alia, elongational viscosity with tension-stiffening behavior. The properties of the degradable polymer may be further tailored to meet some user and/or process designated goal using any suitable methodology such as melt blending and copolymerizing the monomer that provides degradability to the polymer with another monomer, or by changing the macromolecular architecture of the degradable polymer (e.g., hyper-branched polymers, star-shaped, or dendrimers, etc.).

In an embodiment, in choosing the appropriate degradable polymer, an operator may consider the degradation products that will result in addition to the degradable polymer remaining in particulate form in the well treatment fluid under wellbore conditions long enough to complete the intended operation. For example, an operator may choose the degradable polymer such that the resulting degradation products do not adversely affect one or more other operations, treatment components, the formation, or combinations thereof. For example, the degradation products may be water-soluble. Additionally, the choice of degradable polymer may also depend, at least in part, upon the conditions of the well.

In an embodiment, a DM suitable for use in the present disclosure is a particulate material having a particle size ranging from about 25 microns to about 5 mm, alternatively from about 100 microns to about 4 mm, or alternatively from about 500 microns to about 2 mm in diameter.

Nonlimiting examples of additional degradable polymers suitable for use in conjunction with the methods of this disclosure are described in more detail in U.S. Pat. No. 7,841,411, which is incorporated by reference herein in its entirety.

In an embodiment, the degradable polymer further comprises a plasticizer. The plasticizer may be present in an amount sufficient to provide one or more desired characteristics, for example, (a) more effective compatibilization of the melt blend components, (b) improved processing characteristics during the blending and processing steps, (c) control and regulation of the sensitivity and degradation of the polymer by moisture, (d) control and/or adjust one or more properties of the polymer (e.g., strength, stiffness, etc.), or combinations thereof.

Plasticizers suitable for use in the present disclosure include, but are not limited to, polyethylene glycol (PEG); diethylene glycol; polyethylene oxide; N-alkyl pyrrolidones; N-alicyclic pyrrolidones, diethylenediphenylsulfone; 4,4-diphenoxy diphenylsulfone; dioctyl phthalate; dibenzyl phthalate; hydrocarbon oils and the like. Compositions of such plasticizers are described in U.S. Pat. Nos. 6,903,181; 4,902,740; and 4,788,272 (Reissue 33,315) each of which are incorporated by reference herein in their entirety. The choice of an appropriate plasticizer will depend on the particular degradable polymer utilized. It should be noted that, in certain embodiments, when initially formed, the degradable polymer may be somewhat pliable. But once substantially all of the solvent has been removed, the particulates may harden. More pliable degradable polymers may be beneficial in certain chosen applications. The addition of a plasticizer can affect the relative degree of pliability. Also, the relative degree of crystallinity and amorphousness of the degradable polymer can affect the relative hardness of the degradable polymers. In turn, the relative hardness of the degradable polymers may affect the ability of the DA solutions to degrade the degradable polymer at low temperatures.

In an embodiment where a plasticizer of the type disclosed herein is used, the plasticizer may be intimately incorporated within the degradable polymeric materials. DMs of the type disclosed herein may be introduced to the subterranean formation by combination with a carrier fluid to form a pumpable DM-laden composition, slurry, or fluid (also referred to herein as a diverter fluid). In some embodiments, the pumpable DM-laden fluid is a wellbore servicing fluid which, in addition to functioning as a carrier fluid for the DM, comprises additional components and performs one or more intended functions in a wellbore servicing operation. As used herein, a “servicing fluid” refers to a fluid used to drill, complete, work over, fracture, repair, clean-up, acidize, or in any way prepare a wellbore for the recovery of materials residing in a subterranean formation penetrated by the wellbore. Examples of wellbore servicing fluids include, but are not limited to, drilling fluids or muds, fracturing fluids, clean-up fluids, acidizing fluids, or completion fluids, any of which may comprise one or more DMs of the type disclosed herein. The servicing fluid is for use in a wellbore that penetrates a subterranean formation. It is to be understood that “subterranean formation” encompasses both areas below exposed earth and areas below earth covered by water such as ocean or fresh water. Additional aspects of carrier fluids suitable for use in the present disclosure are described in more detail herein.

In an embodiment, one or more DMs of the type disclosed herein are combined with a carrier fluid to form a pumpable composition, slurry, or fluid (e.g., a DM-laden fluid), for example where the carrier fluid is an aqueous wellbore servicing fluid. Herein, an aqueous wellbore servicing fluid refers to a fluid in which water or saltwater is the predominant component of the liquid phase. In an embodiment, the wellbore servicing fluid is an emulsion having aqueous fluid as the external or continuous phase and nonaqueous fluid as the internal or discontinuous phase. In an embodiment, the aqueous fluid component of the wellbore servicing fluid generally comprises any suitable aqueous liquid.

Examples of suitable aqueous fluids include, but are not limited to, sea water, freshwater, naturally-occurring and artificially-created brines containing organic and/or inorganic dissolved salts, liquids comprising water-miscible organic compounds, and combinations thereof. Examples of suitable brines include, but are not limited to, chloride-based, bromide-based, or formate-based brines containing monovalent and/or polyvalent cations and combinations thereof. Examples of suitable chloride-based brines include, but are not limited to, sodium chloride and calcium chloride. Examples of suitable bromide-based brines include, but are not limited to, sodium bromide, calcium bromide, and zinc bromide. Examples of suitable formate-based brines include, but are not limited to, sodium formate, potassium formate, and cesium formate. In an embodiment, the wellbore servicing fluid comprises greater than about 50% aqueous fluid by total weight of fluid, alternatively greater than about 55, 60, 65, 70, 75, 80, 85, or 90%. In an embodiment, the carrier fluid (e.g., wellbore servicing fluid) is acidic and is characterized by a pH of less than about 7.

The DM-laden fluid (e.g., wellbore servicing fluid) may further comprise additional additives as deemed appropriate by one of ordinary skill in the art, with the benefit of this disclosure. Additives may be used singularly or in combination. Examples of such additional additives include, but are not limited to, a surfactant, a crosslinking agent, a breaker, a bridging agent, a weighting agent, and the like, or any combinations thereof. Methods for introducing these additives and their effective amounts are known to one of ordinary skill in the art with the benefits of this disclosure.

In an embodiment, the carrier fluid comprises an aqueous base fluid and is contacted with one or more DMs, and optionally one or more additives, of the type disclosed herein to form a substantially aqueous DM-laden fluid. As used herein, the term “substantially aqueous” may refer to a fluid comprising less than about 25% by weight of a non-aqueous component, alternatively less than about 20% by weight, alternatively less than about 15% by weight, alternatively less than about 10% by weight, alternatively less than about 5% by weight, alternatively less than about 2.5% by weight, alternatively less than about 1.0% by weight of a non-aqueous component. Examples of suitable aqueous fluids include, but are not limited to, water that is potable or non-potable, untreated water, partially treated water, treated water, produced water, city water, well-water, surface water, or combinations thereof. In an alternative or additional embodiment, the DM-laden fluid may comprise an aqueous gel, a viscoelastic surfactant gel, an oil gel, a foamed gel, an emulsion, an inverse emulsion, or combinations thereof.

In an embodiment, the DM may be present in the DM-laden fluid (e.g., wellbore servicing fluid) in an amount of from about 1 lbm/1000 gal to about 1000 lbm/1000 gal, alternatively from about 10 lbm/1000 gal to about 500 lbm/1000 gal, or alternatively from about 50 lbm/1000 gal to about 250 lbm/1000 gal. The carrier fluid may be present in the DM-laden fluid in an amount sufficient to form a pumpable slurry/fluid, and may provide the balance of the DM-laden fluid when all other components are accounted for. In an embodiment, the solubility of DM in DM-laden fluid is less than about 50%, alternatively less than about 25%, or alternatively less than about 10% by weight of carrier fluid.

In an embodiment, the carrier fluid (e.g., wellbore servicing fluid) further comprises a suspending agent in addition to one or more DMs. The suspending agent may function to prevent the DM particulates from settling in the fluid during its storage or before reaching its downhole target (e.g., a portion of the wellbore and/or subterranean formation). In accordance with the methods of the present disclosure, the suspending agent may comprise microfine particulate materials, (e.g., less than about 1 micron) hereinafter referred to as colloidal materials, clays and viscosifying or gel forming polymers.

Nonlimiting examples of colloidal materials suitable for use in the present disclosure include carbon black, lignite, brown coal, humic acid, styrene-butadiene rubber latexes, polyvinyl alcohol latexes, acetate latexes, acrylate latexes, precipitated silica, fumed/pyrogenic silica (such as an oxidation product of SiO₂, SiH₄, SiCl₄ or HSiCl₃), and surfactant micelles.

Nonlimiting examples of clays suitable for use in the present disclosure include bentonite, attapulgite, kaolinite, meta kaolinite, hectorite and sepiolite.

Nonlimiting examples of viscosifying or gel-forming polymers suitable for use in the present disclosure include a copolymer of 2-acrylamido-2-methylpropane sulfonic acid and N,N-dimethylacrylamide, carragenan, scleroglucan, xanthan gum, guar gum, hydroxypropylguar, hydroxyethylcellulose, carboxymethylhydroxyethylcellulose, welan gum, succinoglycan, copolymers or terpolymers of 2-acrylamido-2-methylpropane sulfonate, N,N-dimethylacrylamide, acrylic acid, and vinyl acetate; copolymers of acrylamide and trimethylammoniumethylmethacrylate, trimethylammoniumethyl acrylate salts; and copolymers of 2-acrylamido-2-methylpropane sulfonate and acrylamide. The last two polymers can be used to viscosify acidic fluids containing mineral acids, organic acids or combinations thereof.

In an embodiment, the suspending agent is present in the DM-laden fluid in an amount of from about 0.01 wt. % to about 10 wt. %, alternatively from about 0.1 wt. % to about 5 wt. %, or alternatively from about 0.25 wt. % to about 1.5 wt. %, based on the total weight of the DM-laden fluid. In an embodiment, a DM of the type disclosed herein may function to divert the flow of a wellbore servicing fluid from one area of a subterranean formation to another area of the subterranean formation.

A method of servicing a wellbore may comprise placing a wellbore servicing fluid into a portion of a wellbore. In such embodiments, the wellbore servicing fluid may enter flow paths and perform its intended function (e.g., increasing the production of a desired resource from that portion of the wellbore). The level of production from the portion of the wellbore that has been stimulated may taper off over time such that treatment (e.g., fracturing and/or stimulation) of a different portion of the well is desirable. Additionally or alternatively, previously formed flowpaths may need to be temporarily plugged in order to further treat (e.g., fracture and/or stimulate) additional/alternative intervals or zones during a given wellbore service or treatment. In an embodiment, a DM of the type disclosed herein is delivered to the wellbore in an amount sufficient to effect diversion of a wellbore servicing fluid (e.g., a fracturing fluid and/or acidizing fluid) from a first flowpath (e.g., a first zone or interval) to a second flowpath (e.g., a second zone or interval). The DM may be placed into the subterranean formation via pumping a slug of a DM-laden fluid (e.g., a carrier fluid such as water containing one or more DMs and one or more suspending agents, and optionally other components such as proppants, acids, etc.) and/or by adding the DM directly to a wellbore servicing fluid, for example to create a slug of fracturing fluid comprising the DM. The DM may form a diverter plug at a first location (and any subsequent location so treated) such that the wellbore servicing fluid (e.g., a fracturing fluid) may be selectively diverted and placed at one or more additional locations that are not impeded by the DM plug, for example during a multi-stage fracturing operation.

Thus, within a first treatment stage, the process of introducing a wellbore servicing fluid into the formation to perform an intended function (e.g., fracturing or stimulation) and, thereafter, diverting the wellbore servicing fluid to another flowpath into the formation and/or to a different location or depth within a given flowpath may be continued until some user and/or process goal is obtained. In an additional embodiment, this diverting procedure may be repeated with respect to each of a second, third, fourth, fifth, sixth, or more, treatment stages, for example, as disclosed herein with respect to the first treatment stage. Subsequent to diverting associated with one or more treatment stages, all or a portion of the diverter material may be removed as disclosed herein, for example to prepare the wellbore for production of hydrocarbons.

In an embodiment, a method of the present disclosure comprises servicing a wellbore by placing a fluid (e.g., wellbore servicing fluid such as a fracturing fluid and/or acidizing fluid) comprising a DM of the type disclosed herein (i.e., polyimide) into a wellbore and subjecting the wellbore to one or more wellbore servicing operations. The DM may form a temporary plug in a zone of high-permeability within the wellbore or formation and divert the flow of fluid from the zone of high-permeability to another location in the wellbore/formation. Thus, the presence of the DM reduces the permeability of the formation in the location where deposited. In an embodiment, subsequent to the placement of the DM material (e.g., formation of a diverter plug), for example after fracturing and/or acidizing one or more zones in a wellbore/formation, the method may comprise removal of at least a portion of the DM from the wellbore. Any suitable methodology for removal of the DM is contemplated. In an embodiment, following a wellbore servicing operation utilizing a diverting fluid (e.g., a wellbore servicing fluid such as a fracturing fluid and/or an acidizing fluid comprising a DM), the wellbore and/or the subterranean formation may be prepared for production, for example, production of a hydrocarbon, therefrom by removal of all or a portion of the DM.

In an embodiment the DM comprises a degradable polymer of the type previously disclosed herein, which degrades due to, inter alia, a chemical process such as hydrolysis. As may be appreciated by one of skill in the art upon viewing this disclosure, the degradability of a polymer may depend at least in part on its backbone structure. As may also be appreciated by one of skill in the art upon viewing this disclosure, the rates at which such polymers degrade may be at least partially dependent upon polymer characteristics such as the type of repetitive unit, composition, sequence, length, molecular geometry, molecular weight, morphology (e.g., crystallinity, size of spherulites, and orientation), hydrophilicity, hydrophobicity, surface area, and type of additives. Additionally, the ambient downhole environment to which a given polymer is subjected may also influence how it degrades, (e.g., temperature, presence of moisture, oxygen, microorganisms, enzymes, pH, pressure, salt content and type).

In an embodiment, at least a portion of the DM is removed from the formation by contacting the DM with one or more degradation accelerators (DA). In an embodiment, a DA comprises a material suitable for placement in a wellbore formation along with a DM that functions to enhance the rate of degradation of a DM. It is to be understood that the DA functions to accelerate degradation of the DM at a suitable time when added together, and further that the DM may be degraded to an extent sufficient to restore permeability of the formation. As such, the DM may not be completely degraded (i.e., less than 100%).

In an embodiment, the DA comprises an amino alcohol (i.e., alkanolamine) or an amino alcohol precursor. Non-limiting examples of amino alcohols suitable for use in this disclosure include ethanolamine, N,N-dimethylethanolamine, triethanolamine, triisopropanolamine, 3-amino-1,2-propanol, diethanolamine, and the like. In an embodiment, the pKa of conjugate acid of the amino alcohol compound is greater than about 9, alternatively greater than about 10, or alternatively greater than 11.

In an embodiment, the DA may be in the form of an amino alcohol precursor, wherein the amino group of the amino alcohol may be protected by a protective group. In such embodiments, the presence of the protective group may reduce or prevent premature degradation of the DM when contacted with the DA. Herein an amino alcohol precursor is defined as a material or combination of materials that provides for delayed release of one or more amine groups present in the amino alcohols. As such the amino alcohol precursor does not act as an amino compound by significantly accelerating the degradation of a DM to which it is introduced, but will, upon degradation, yield one or more components capable of acting as an accelerator for the degradation of the DM.

An amino alcohol that contains a protective group on its amino function may be designated as a protected amino alcohol. Without wishing to be limited by theory, a protective group may be introduced into a molecule by chemical modification of the amino functional group (e.g., amine group) to render it less basic, and may be removed under specific conditions to enable the reactivity of the previously protected group.

Nonlimiting examples of protective groups suitable for use in the present disclosure include amine protective groups, amide groups, carbamate groups, carboxybenzyl groups, p-methoxybenzyl carbonyl groups, tert-butyloxycarbonyl groups, 9-fluorenylmethyloxycarbonyl groups, acetyl groups, benzoyl groups, benzyl groups, p-methoxybenzyl groups, 3,4-dimethoxybenzyl groups, p-methoxyphenyl groups, sulfonamides, tosyl groups, nosyl groups, and the like, or combinations thereof.

The protective group may be acted upon in any fashion (e.g., chemically, physically, thermally, etc.) and under any conditions compatible with the components of the process in order to release the amino alcohol at some user and/or process desired time and/or under desired conditions such as in situ wellbore conditions. In an embodiment, the amino alcohol precursors may comprise at least one protected amino alcohol, such that when acted upon and/or in response to pre-defined conditions (e.g., in situ wellbore conditions such as temperature, pressure, chemical environment), an amino alcohol is released. In an embodiment, the amino alcohol precursor may comprise an amino alcohol that is released after exposure to an elevated temperature such as an elevated wellbore temperature (e.g., greater than about 150° F.). In an embodiment, the amino alcohol precursor comprises a material which reacts with one or more components of the wellbore servicing fluid (e.g., reacts with a component of the base aqueous fluid present in the wellbore servicing fluid, e.g., fracturing fluid and/or acidizing fluid) to liberate at least one amino alcohol species. The DM may be degraded via hydrolytic or aminolytic degradation in the presence of the amino alcohol in its unprotected form.

In an embodiment, the amino alcohol precursor may be characterized as exhibiting a suitable delay time. As used herein, the term “delay time” refers to the period of time from when an amino alcohol precursor, or a combination of amino alcohol precursors, is introduced into an operational environment until the amino alcohol precursor or combination of precursors begins to increase the degradation rate of the DM. In an embodiment, the amino alcohol precursors may exhibit an average delay time of at least about 1 hour, alternatively at least about 2 hours, alternatively at least about 4 hours, alternatively at least about 8 hours, alternatively at least about 12 hours, alternatively at least about 24 hours. In such embodiments, where the DA comprises an amino alcohol precursor, the DA may be placed downhole about concurrently with the DM. For example, the DA may be fashioned so as to accelerate degradation of the DM subsequent to the DM performing its intended function.

In an embodiment, the amino alcohol precursor may be characterized as operable, as disclosed herein, within a suitable temperature range. As will be appreciated by one of skill in the art viewing this disclosure, differing amino alcohol precursors may exhibit varying temperature ranges of operability. As such, in an embodiment, an amino alcohol precursor, or combination of amino alcohol precursors, may be selected for inclusion in the DM-laden fluid such that the amino alcohol precursor(s) exhibit a desired operable temperature range (e.g., an ambient downhole temperature for a given wellbore). In addition, as will also be appreciated by one of skill in the art viewing this disclosure, the degradation of the amino alcohol precursor may be influenced by the temperature of the operational environment. For example, generally the rate of degradation of a given amino alcohol precursor will be higher at higher temperatures. As such, the rate of degradation of a given amino alcohol precursor may be generally higher when exposed to the environment within the wellbore.

In an embodiment, the DA is a base or base precursor. A base precursor includes any compound capable of generating hydroxyl ions (HO⁻) in water. It is to be understood that the base-precursor can include chemicals that produce a base when reacted together. Without limitation, examples of base-producing reactions include the reaction of an oxide with water. Nonlimiting examples of base precursors suitable for use in this disclosure include ammonium and alkali metal carbonates and bicarbonates, alkali and alkali earth metal oxides, alkali and alkali earth metal hydroxides, alkali and alkaline earth metal phosphates and hydrogen phosphates, alkali and alkaline earth metal sulphides, alkali and alkaline earth metal salts of silicates and aluminates, alkali and alkaline earth metal carboxylates, water soluble or water dispersible organic amines, or combinations thereof. In an embodiment, the base is not ammonium hydroxide. Other examples of bases suitable for use as DAs in this disclosure are described in more detail in U.S. Patent Publication No. 20100273685 A1, which is incorporated by reference herein in its entirety. The organic amines may be used in their protected forms in a manner similar to the use of protected aminoalcohols discussed herein to delay DM degradation when present together with a DM in a wellbore servicing fluid.

Nonlimiting examples of ammonium, alkali and alkaline earth metal carbonates and bicarbonates suitable for use in this disclosure include NH₄CO₃, Na₂CO₃, K₂CO₃, (NH₄)HCO₃, NaHCO₃, and KHCO₃. It is to be understood that when carbonate and bicarbonate salts are used as base-producing material, a byproduct may be carbon dioxide.

Nonlimiting examples of alkali and alkaline earth metal hydroxides suitable for use in this disclosure include NaOH, KOH, LiOH, Ca(OH)₂ and Mg(OH)₂.

Nonlimiting examples of alkali and alkaline earth metal oxides suitable for use in this disclosure include BaO, SrO, Li₂O, CaO, Na₂O, K₂O, MgO, and the like. Nonlimiting examples of alkali and alkali earth metal phosphates and hydrogen phosphates suitable for use in this disclosure include Na₃PO₄, K₃PO₄, Ca₃(PO₄)₂, and the like. Nonlimiting examples of alkali and alkaline earth metal sulphides suitable for use in this disclosure include Na₂S, CaS, SrS, and the like. Examples of alkali and alkaline earth metal silicates and aluminates include sodium silicate, potassium silicate, sodium metasilicate, sodium aluminate, calcium aluminate and the like, or combinations thereof. In an embodiment, the base comprises silicate and aluminate salts with some solubility in aqueous solutions.

In an embodiment, the DA is an organic amine or an organic amine precursor. Examples of suitable organic amines include ethylene diamine, diethylene triamine, triethylene tetramine, and tetraethylene pentamine. In an embodiment, the pKa of conjugate acid of the organic amine compound is greater than about 9, alternatively greater than about 10, or alternatively greater than about 11.

In an embodiment, the base or base precursor is used in an encapsulated form. In an embodiment the pH of wellbore servicing fluid comprising the degradation material is greater than about 9, alternatively greater than about 10, alternatively greater than about 11. In an embodiment, the pKa of conjugate acid of the organic amine compound is greater than about 9, alternatively greater than about 10, or alternatively greater than about 11.

In an embodiment, the DM and DA comprising an amino alcohol of the type disclosed herein are used together in an acidic wellbore servicing fluid without the need for protecting the amino group of the amino alcohol or organic amine to prevent premature degradation of the DM. Without being limited by theory, the protonation of the amine groups by the acid in the wellbore servicing fluid deactivates the DA until a suitable time when the acid becomes ‘spent’ or becomes consumed by reactions with the formation surfaces, and the pH of the fluid increases to the values at which the free amine groups are released, for example when the pH of the flowback fluid is equal to or greater than about 7.

In an embodiment, DAs suitable for use in the present disclosure may accelerate the degradation of the DM over a broad temperature range advantageously providing a DM that can be utilized and removed in a temperature range of from about 60° F. to about 400° F., alternatively from about 110° F. to about 325° F., or alternatively from about 180° F. to about 250° F.

In an embodiment, the DA may be contacted with the DM in an amount of from about 10 mole percent (mole %) to about 110 mole %, alternatively from about 25 mole % to about 75 mole % or alternatively from about 40 mole % to about 60 mole % based on the number of moles of monomer or imide groups present in the amount of DM placed in the wellbore.

In an embodiment, the wellbore servicing fluid comprises a phase transfer catalyst (PTC), in combination with the DA. The PTC may comprise a material that functions to enhance the rate of degradation of a DM by a DA. Without wishing to be limited by theory, a PTC enables the transfer of chemical species (e.g., hydroxide ion) between two phases (i.e., solid phase and liquid phase). As will be understood by one of ordinary skill in the art, the PTC enables the transfer of the chemical species but does not participate in the chemical reaction between the chemical species and the phase into which it is being transferred. Without wishing to be limited by theory, the PTC functions as a catalyst in a heterogeneous catalysis process.

In an embodiment, the PTC comprises a cationic compound that (i) is water dispersible; (ii) has a water solubility less than about 5 wt. %, alternatively less than about 2 wt. %, or alternatively less than about 1 wt. %; (iii) has a logarithmic octanol-water distribution coefficient, Log D_{OW}, greater than about 1, alternatively greater than about 2, or alternatively greater than about 3; and/or (iv) has a hydrophilic-lipophilic balance (HLB) ratio of from about 7 to about 11. The water solubility of a compound may be defined as the maximum amount of the compound that will dissolve in pure water at a specified temperature and pressure. Herein the solubility in wt. % refers to the grams of dissolved substance in 100 grams of water. The Log D_{OW} of a compound may be defined as the ratio of the compound's concentration in a known volume of n-octanol to its concentration in a known volume of water after the n-octanol and water have reached equilibrium. D_{OW} may be determined by the Shake Flask method or High Pressure Liquid Chromatography (HPLC) HLB ratio is defined as a ratio of hydrophilic and lipophilic groups of a surfactant, and is a measure of the balance between the oil-soluble and water-soluble moieties in a surface active material (i.e., a surfactant) HLB values range between 0-60, with smaller vales (for example, <10) representing oil soluble surfactants with affinity for hydrophobic fluids and higher values (for example >10) representing water soluble surfactants with affinity for aqueous or hydrophilic fluids.

In an embodiment, the PTC comprises a cationic surfactant. Without wishing to be limited by theory, a surfactant may be defined as a compound that lowers the interfacial tension between a liquid and a solid, at the interface (i.e., where the liquid phase and the solid phase contact each other). In an embodiment, the cationic PTC comprises a quaternary ammonium salt, a quaternary phosphonium salt, a quaternary arsonium compound, alkyl pyridinium salts or combinations thereof.

Nonlimiting examples of quaternary ammonium salts suitable for use in this disclosure include trioctylmethylammonium chloride (TOMAC), tri(decyl)methylammonium chloride, tricetylmethylammonium chloride (TCMAC), dimethyl(hydrogenatedtallow)benzyl ammonium chloride (DMHTBAC), di(dodecyl)benzylmethylammonium chloride, tetraheptylammonium chloride, di(cetyl)dimethylammonium chloride, tri(decyl)benzylammonium chloride or combinations thereof. In an embodiment, the PTC is not the conjugate acid salt obtained by protonation of a tertiary amine by an acid. In an embodiment, the structure of the PTC is not pH-sensitive.

In an embodiment, the quaternary ammonium salt may be obtained from tertiary amines of the type described herein via a Menshutkin reaction. Without wishing to be limited by theory, the Menshutkin reaction is an alkylation reaction of tertiary amines, wherein the alkylation agent is an alkyl halide. Nonlimiting examples of alkyl halides suitable for use in this disclosure include methyl chloride, methyl bromide, ethyl chloride, ethyl bromide, propyl chloride, propyl bromide, butyl bromide, and the like. In an embodiment, tertiary amines suitable for the Menshutkin reaction as previously described herein comprises an amine generally represented by Formula II:

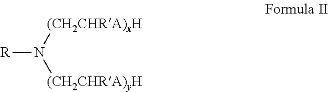

wherein R is an organic group having from about 12 to about 22 carbon atoms (e.g., a C₁₂ to C₂₂), R′ is independently selected from hydrogen or C₁ to C₃ alkyl group, A is NH or O, and the sum of x and y ranges from about 1 to about 3, alternatively, from 1 to 3 (e.g., 1≦x+y≦3), alternatively, from greater than 1 to less than 3 (e.g., 1<x+y<3). In an embodiment, the R group may be a C₁₂ to C₂₂ aliphatic hydrocarbon. Alternatively, R may be a non-cyclic aliphatic. In an embodiment, the R group comprises at least one degree of unsaturation. For example, at least one carbon-carbon double bond may be present within the R group. Examples of groups suitable for use as R include, but are not limited to, commercially recognized mixtures of aliphatic hydrocarbons such as soya, which is a mixture of C₁₄ to C₂₀ hydrocarbons, or tallow which is a mixture of C₁₆ to C₂₀ aliphatic hydrocarbons, or tall oil which is a mixture of C₁₄ to C₁₈ aliphatic hydrocarbons. In an embodiment in which the A group comprises NH, the sum of x and y may be 2 and the value of x may be 1. In yet another embodiment in which the A group comprises O, the sum of x and y may be 2 and the value of x may be 1. In another embodiment, a tertiary amine suitable for the Menshutkin reaction as previously described herein comprises an amine generally represented by Formula II wherein R is a cycloaliphatic hydrocarbon, each R′ may be the same or different and is H or an alkyl having from about 1 to about 3 carbon atoms, each A may be the same or different and is NH or O, and the sum of x and y ranges from about 1 to about 20, alternatively, from 1 to 20 (e.g., 1≦x+y≦20), alternatively, from greater than 1 to less than 20 (e.g., 1<x+y<20). In an embodiment, R may comprise an aromatic group. In an embodiment, R comprises abietyl, hydroabietyl, dihydroabietyl, tetrahydroabietyl, dehydroabietyl or combinations thereof; R′ is H, and A is O. In another embodiment, the amine is an ethoxylated rosin amine. As used herein, the term “rosin amine” refers to the primary amines derived from various rosins or rosin acids, whereby the carboxyl of the rosin or rosin acid is converted to an amino (—NH₂) group. Examples of suitable rosin amines include, but are not limited to, gum and wood rosin amines primarily containing abietyl, rosin amine derived from hydrogenated gum or wood rosin and primarily containing dehydroabietylamine, rosin amine derived from hydrogenated gum or wood rosin and primarily containing dihydro- and tetrahydroabietylamine, heat-treated rosin amine derived from heat-treated rosin, polymerized rosin amine derived from polymerized rosin, isomerized rosin amine derived from isomerized rosin and containing substantial amounts of abietylamine, rosin amines derived from pure rosin acids (e.g., abietylamine, dihydroabietylamine, dehydroabietylamine, and tetrahydroabietylamine), or combinations thereof.

Nonlimiting examples of quaternary phosphonium salts suitable for use in this disclosure include hexadecyltributylphosphonium bromide, tetrabutylphosphonium chloride, tri(butyl)octylphosphonium chloride, tri(butyl)hexadecylphosphonium chloride, or combinations thereof. In an embodiment, the quaternary phosphonium salt comprises tri(butyl)hexadecylphosphonium chloride. Quaternary phosphonium compounds are commercially available under the trade name of CYPHOS from Cytec Industries, Woodland Park, N.J., USA.

In an embodiment, the DA and PTC are combined with one or more additional components, for example an aqueous or non-aqueous base fluid and optionally one or more additives, to form a pumpable wellbore servicing fluid of the type described herein. In an embodiment, the DA and the PTC are each present in the wellbore servicing fluid in amounts effective to perform its intended function. Thus, the amount of DA may range from about 0.5 weight percent (wt. %) to about 20 wt. %, alternatively from about 1 wt. % to about 10 wt. %, or alternatively from about 2 wt. % to about 5 wt. %, based on the total weight of the wellbore servicing fluid, while the amount of PTC may range from about 0.001 wt. % to about 2 wt. %, alternatively from about 0.01 wt. % to about 1 wt. %, or alternatively from about 0.1 wt. % to about 0.5 wt. %, based on the total weight of the wellbore servicing fluid.

DA/PTCs of the type disclosed herein may catalyze the degradation of DMs of the type disclosed herein. In an embodiment, a DA/PTC combination suitable for use in the present disclosure produces water-soluble degradation products. For example, the DA/PTC when contacted with a DM of the type disclosed herein (e.g., when contacted in situ within the wellbore) produces degradation products that are in the salt form, for example the alkali metal salt (e.g., the sodium salt of the degradation product). The salt form of the degradation product is readily soluble in water.

In an embodiment, a DM of the type disclosed herein (i.e., polyimide) is stable in an acidic environment, i.e., the DM does not degrade at a pH of less than about 4, alternatively less than about 3, alternatively less than about 2, or alternatively less than about 1.

In an embodiment, a DM of the type disclosed herein (i.e., polyimide) is utilized as a temporary plug in acid stimulation treatments such as matrix-acidizing and fracture-acidizing operations. Acidizing and fracturing treatments using aqueous acidic solutions are commonly carried out in subterranean formations to increase the permeability of the formation. The resultant increase in formation permeability normally results in an increase in the recovery of hydrocarbons from the formation.

Acidizing techniques may be carried out as “matrix acidizing” procedures or as “acid fracturing” procedures. Generally, in acidizing treatments, aqueous acidic solutions are introduced into the subterranean formation under pressure so that the acidic solution flows into the pore spaces of the formation to remove near-well formation damage and other damaging substances. The acidic solution reacts with acid-soluble materials contained in the formation which results in an increase in the size of the pore spaces and an increase in the permeability of the formation. This procedure commonly enhances production by increasing the effective well radius. When performed at pressures above the pressure required to fracture the formation, the procedure is often referred to as acid fracturing. Acid fracturing involves the formation of one or more fractures in the formation and the introduction of an aqueous acidizing fluid into the fractures to etch the faces of the fracture whereby flow channels are formed when the fractures close. The aqueous acidizing fluid also enlarges the pore spaces in the fracture faces and in the formation. The use of the term “acidizing” herein refers to both types of acidizing treatments, and more specifically, refers to the general process of introducing an acid down hole to perform a desired function, e.g., to acidize a portion of a subterranean formation or any damage contained therein.

In an embodiment, the wellbore service being performed is an acidizing treatment operation, wherein an acidizing fluid is placed (e.g., pumped downhole) at a first location in the formation and a DM is employed to divert the acidizing fluid from the high permeability zones into the low permeability zones, such that the acidizing treatment can be carried out at in the low permeability zones as well. For the purposes of this disclosure, a high permeability zone has a permeability of from about 0.5 Darcy to about 50 Darcy, alternatively from about 1 Darcy to about 20 Darcy, or alternatively from about 5 Darcy to about 10 Darcy; and a low permeability zone has a permeability of from about 1×10E-6 Darcy to about 0.5 Darcy, alternatively from about 1×10E-3 Darcy to about 0.250 Darcy, or alternatively from about 0.01 Darcy to about 0.1 Darcy. The DM may be placed into the high permeability zones via pumping a slug of a fluid (e.g., a fluid having a different composition than the acidizing fluid) containing the DM and/or by adding the DM directly to the acidizing fluid, for example to create a slug of fracturing fluid comprising the DM.

In an embodiment, a method of servicing a wellbore comprises placing into the wellbore a first acidizing fluid, comprising one or more DMs of the type disclosed herein, and a PTC. The DM/PTC may form a plug that obstructs one or more flowpaths. In such embodiments, a second wellbore servicing fluid comprising a DA which is an inorganic base of the type disclosed herein. The DA may contact the DM/PTC plug and the DM degradation is accelerated by the combination of DA and PTC.

In an embodiment a method of servicing a wellbore comprises placing into the wellbore an acidizing fluid, a DM of the type disclosed herein, and a DA comprising an amino alcohol, or an organic amine. The DA in the presence of the acidic fluid does not function to degrade the DM. However, upon completion of the wellbore servicing operation (i.e., acidizing), the DA may be activated by the less acidic flow back fluid upon placing the well on production cycle. The pH of the flowback fluid may be equal to or greater than about 7 for activation of the DA (e.g., amine or amino alcohol).

In an embodiment, an acidizing treatment may be used to acidize a portion of a subterranean formation or any damage contained therein. The term “damage” as used herein refers to undesirable deposits in a subterranean formation that may reduce its permeability. Scale, skin, gel residue, and hydrates are contemplated by this term. Also contemplated by this term are geological deposits, such as, but not limited to, carbonates located on the pore throats of a sandstone in a subterranean formation.

More details regarding wellbore acidizing operations suitable for use in this disclosure are described in U.S. Patent App. No. 20080035342 A1, which is incorporated by reference herein in its entirety.

When it is desirable to prepare a wellbore servicing fluid comprising a DM of the type disclosed herein for use in a wellbore, the fluid may be prepared at the wellsite or transported to and, if necessary, stored at the on-site location and subsequently combined with additional components to form the diverting fluid. In an embodiment, additional diverting materials may be added to the diverting fluid on-the-fly along with the other components/additives. The resulting diverting fluid may be pumped downhole where it may function as intended (e.g., by depositing the DM material to form a diverter plug at a desired location downhole, thereby diverting subsequently pumped wellbore servicing fluid to another location in the wellbore and/or formation).

The concentrations of the components in the diverting fluid can be adjusted to their desired amounts before delivering the composition into the wellbore. Those concentrations thus are not limited to the original design specification of the diverting fluid and can be varied to account for changes in the downhole conditions of the wellbore that may occur before the composition is actually pumped into the wellbore.

Alternatively, the concentration of the components of the diverting fluid can be adjusted to their desired amounts as the composition is placed in the wellbore or formation. For example, the DM may be introduced to the wellbore as a concentrated DM-laden slurry (e.g., as a first stream pumped down the flowbore of a tubular inserted into a wellbore) of the typed disclosed herein which is contacted with a diluent (e.g., as a second stream pumped in an annular space formed between a tubular inserted into a wellbore) to form a DM-containing fluid having some user and/or process-desired concentration. In an embodiment, the diluent may comprise a suitable aqueous fluid, aqueous gel, viscoelastic surfactant gel, oil gel, a foamed gel, emulsion, inverse emulsion, or combinations thereof. In an embodiment, the diluent may have a composition substantially similar to that of the concentrated DM-slurry; alternatively, the diluent may have a composition different from that of the concentrated DM-laden slurry.

In an embodiment, the size and/or shape of the DM may be chosen so as to provide a plug (e.g., filter cake) within a given flowpath (e.g., within a point of entry into the wellbore and/or at a given distance from the wellbore within a fracture) having a given size, shape, and/or orientation. In an embodiment, the DM may be added to the wellbore servicing fluid to generate a diverting fluid which is then pumped downhole at the same time with additional diverting material (e.g., non-polyimide diverter material).

In an embodiment, the DM and the DA/PTC combination may be added to the same wellbore servicing fluid and delivered into the wellbore as a single stream wellbore servicing fluid. In another embodiment, the DM may be added to the wellbore servicing fluid and delivered into the wellbore as a first wellbore servicing fluid stream. Once the DM has served its purpose, the DA/PTC combination may be delivered into the wellbore as a subsequent (e.g., second) wellbore servicing fluid stream, to effect the degradation of the DM. In various embodiments, one or more additional wellbore servicing fluids (e.g., fracturing fluids, drilling fluids, production enhancement fluids such as acidizing fluids, etc.) may be placed into the wellbore and/or surrounding formation intermediate the first wellbore servicing fluid comprising a DM and a subsequent wellbore servicing fluid comprising a DA/PTC combination.

In an embodiment, the DA and the PTC may be mixed together prior to adding them into the wellbore servicing fluid. In another embodiment, the DA and the PTC are added simultaneously to the wellbore servicing fluid. In yet another embodiment, the DA is added first to the wellbore servicing fluid, and then the PTC is added to the wellbore servicing fluid. In another embodiment, the PTC is added first to the wellbore servicing fluid, and then the DA is added to the wellbore servicing fluid.

In an embodiment, the DA and the PTC are manufactured and then mixed together at the well site. Alternatively, the DA and the PTC are manufactured and then mixed together off-site. In another embodiment, either the DA or the PTC is preformed and the other one would be made on-the-fly (e.g., in real time or on-location), and the two materials would then be mixed together on-the-fly. When manufactured or assembled off site, the DA, PTC and/or combination thereof may be transported to the well site.

In an embodiment, a DA/PTC combination may be prepared in the form of a concentrated liquid additive. In an embodiment, the DA/PTC concentrated liquid additive and a wellbore servicing fluid may be mixed until the DA/PTC is distributed throughout the fluid. By way of example, the DA/PTC concentrated liquid additive and a wellbore servicing fluid may be mixed using a mixer, a blender, a stirrer, a jet mixing system, or other suitable device.

When it is desirable to prepare a wellbore servicing fluid of the type disclosed herein (i.e., a diverting fluid) for use in a wellbore, a base diverting fluid prepared at the wellsite or previously transported to and, if necessary, stored at the on-site location may be combined with the DM, additional water and optional other additives to form the diverting fluid or fluids. In an embodiment, additional diverting materials may be added to the diverting fluid on-the-fly along with the other components/additives. The resulting diverting fluid may be pumped downhole where it may function as intended (e.g., depositing the diverting material in a desired location downhole).

In an embodiment, a DA/PTC concentrated liquid additive is mixed with additional water to form a diluted liquid additive, which is subsequently added to a wellbore servicing fluid (e.g., a degrading fluid). The additional water may comprise fresh water, salt water such as an unsaturated aqueous salt solution or a saturated aqueous salt solution, or combinations thereof. In an embodiment, the liquid additive comprising the DA/PTC is injected into a delivery pump being used to supply the additional water to a fluid composition. As such, the water used to carry the DA/PTC and this additional water are both available to the fluid such that the DA/PTC may be distributed throughout the servicing fluid (e.g., a degrading fluid).

In an alternative embodiment, the DA/PTC combination prepared as a liquid additive is combined with a ready-to-use wellbore servicing fluid (e.g., a degrading fluid) as the fluid is being pumped into the wellbore. In such embodiments, the DA/PTC liquid additive may be injected into the suction of the pump. In such embodiments, the liquid additive can be added at a controlled rate to the fluid (e.g., or a component thereof such as blending water) using a continuous metering system (CMS) unit. The CMS unit can also be employed to control the rate at which the liquid additive is introduced to the fluid or component thereof as well as the rate at which any other optional additives are introduced to the fluid or component thereof. As such, the CMS unit can be used to achieve an accurate and precise ratio of water to DA/PTC concentration in the fluid such that the properties of the fluid (e.g., density, viscosity), are suitable for the downhole conditions of the wellbore. The concentrations of the components in the fluid, e.g., the DA/PTC components, can be adjusted to their desired amounts before delivering the composition into the wellbore. Those concentrations thus are not limited to the original design specification of the fluid and can be varied to account for changes in the downhole conditions of the wellbore that may occur before the composition is actually pumped into the wellbore.

In an embodiment, the DM is combined with PTC by addition to the wellbore servicing fluid to form a pumpable first wellbore servicing fluid for placement of the DM. The DA (for, example sodium hydroxide) may be added to the wellbore servicing fluid to form a second wellbore servicing fluid. In an embodiment, the solid DM is precoated with the PTC by any of the several methods. When the PTC is low a melting solid, the PTC may be melt-coated on DM by hot rolling or jet-spraying method. Alternatively, the DM may be spray coated with solutions of PTC in organic solvents such as oxygenated solvents, and dried. Alternately, the DM may be melt-blended with the PTC. A first pumpable wellbore servicing fluid containing PTC-coated or PTC-DM melt blend is placed in the wellbore, and/or the surrounding formation. A second wellbore servicing fluid comprising the DA solution (for example sodium hydroxide solution) may then be brought into contact with the DM supplied with PTC.

In an embodiment, the size and/or shape of the DM may be chosen so as to provide a plug (e.g., filter cake) within a given flowpath (e.g., within a point of entry into the wellbore and/or at a given distance from the wellbore within a fracture) having a given size, shape, and/or orientation. In an embodiment, the DM and/or the DM/PTC may be added to the wellbore servicing fluid to generate a diverting fluid which is then pumped downhole at the same time with additional diverting material.

In an embodiment, the DM once placed downhole enters the formation and forms a diverter plug within a flowpath thereby temporarily lowering the permeability of, and fluidloss to the flowpath. Because of the wide array of flowpaths, induced or natural, and geometries; and a lack of reliable information about their exact dimensions, it is challenging to specify the characteristics of the diverting plug or cake that may be formed by DMs in the flow path. The effectiveness of a diverter fluid in diversion applications is indicated by an increase in pump pressure during DM placement upon formation of a competent plug or filtercake in the flowpath. By monitoring the pressure increase during pumping phase of DM fluid, decisions can be made either to modify the fluid design, for example changing the concentration of DM, or to proceed with the following operation (for example, fracturing at a different cluster of perforations). A pressure increase of greater than about 100 psi, alternatively greater than about 200 psi, or alternatively greater than about 400 psi is taken as indicative of competent plug formation in a flowpath.

In an embodiment, the DM may be configured, for example, via selection of a given size and/or shape, for placement at a given position (e.g., at a given depth of the wellbore) within such a flowpath. Without wishing to be limited by theory, where it is desired that a diverter plug forms in the near-wellbore region, the DM may be selected so as to have a larger particle size (e.g., greater than about 1 mm in diameter or less than about 18 U.S. mesh size); alternatively, where it is desired that a diverter plug forms in the far-wellbore region, the DM may be selected so as to have a smaller particle size (e.g., smaller than about 500 microns in diameter or greater than about 35 U.S mesh size). The near-wellbore region delimitation is dependent upon the formation where the wellbore is located, and is based on the wellbore surrounding conditions. The far-wellbore region is different from the near-wellbore region in that it is subjected to an entirely different set of conditions and/or stimuli. In an embodiment, the near-wellbore and far-wellbore regions are based on the fracture length propagating away from the wellbore. In such embodiments, the near-wellbore region refers to about the first 20% of the fracture length propagating away from the wellbore (e.g., 50 feet), whereas the far-wellbore region refers to a length that is greater than about 20% of the fracture length propagating away from the wellbore (e.g., greater than about 50 feet). Again, without wishing to be limited by theory, smaller diverter particles may be carried a greater distance into the formation (e.g., into an existing and/or extending fracture).

In an embodiment, a diverter fluid comprises a base fluid (e.g., an aqueous fluid such as water), a polymer comprising imide functional groups in the polymer backbone (e.g., polyimide, polyimide ester, or a polyamide imide), and a suspending agent (e.g., a copolymer of 2-acrylamido-2-methyl-propane sulfonate and acrylamide), and said diverter fluid is placed downhole to form a diverter plug. In such an embodiment, the diverter plug may be partially or completed removed via subsequent contact with a degradation accelerator (e.g., PTC/inorganic base combination, or a solution of alkanolamine or organic amine). For example, such a diverter fluid may be used to divert flow of a wellbore servicing fluid from a first location to a second location in a formation.

In an embodiment, a diverter fluid is a DM-laden fracturing fluid comprising a base fluid (e.g., an aqueous fluid such as water), proppant (e.g., sand), a polymer comprising imide functional groups in the polymer backbone (e.g., polyimide, polyimide ester, or a polyamide imide), a suspending agent (e.g., a gum such as xanthan or a guar-based gum), and optionally other components such as a crosslinked gel system, and said diverter fluid is placed downhole to form a diverter plug. For example, such a diverter fluid may be used to divert flow of a fracturing fluid from a first location to a second location in a formation. In such an embodiment, the diverter plug may be partially or completed removed via subsequent contact with degradation accelerator (e.g., PTC/inorganic base combination, or a solution of alkanolamine, or organic amine).

In an embodiment, a diverter fluid is a DM-laden acidizing fluid comprising a base fluid, (e.g., an aqueous fluid such as water), an acid such as hydrochloric acid, hydrofluoric acid, acetic or formic acid or any combination thereof, a polymer comprising imide functional groups in the polymer backbone (e.g., polyimide, polyimide ester, or a polyamide imide) a PTC (e.g., trioctylmethylammonium chloride), a suspending agent (e.g., a synthetic polymer such as 2-acrylamido-2-methylpropane sulfonic acid/acrylamide copolymer, or trimethylammoniumethyl methacrylate/acrylamide copolymer), and optionally other components, and said diverter fluid is placed downhole to form a diverter plug. For example, such a diverter fluid may be used to divert flow of an acidizing fluid from a first location to a second location in a formation. In such an embodiment, the diverter plug may be partially or completed removed via subsequent contact with degradation accelerator (e.g., sodium hydroxide or potassium hydroxide).

In an embodiment, a diverter fluid is a DM-laden acidizing fluid comprising a base fluid, (e.g., an aqueous fluid such as water), an acid such as hydrochloric acid, hydrofluoric acid, acetic or formic acid or any combination thereof, a polymer comprising imide functional groups in the polymer backbone (e.g., polyimide, polyimide ester, or a polyamide imide), an organic amine based-DA agent (an alkanolamine, an amine or an organic amine), a suspending agent (e.g., a synthetic polymer such as 2-acrylamido-2-methylpropane sulfonic acid/acrylamide copolymer, or trimethylammoniumethyl methacrylate/acrylamide copolymer), and optionally other components, and said diverter fluid is placed downhole to form a diverter plug. In such an embodiment, the diverter plug may be partially or completed removed by placing the well back on production to allow the flow back fluid from the formation to degrade the DM by with the organic DA which is activated by neutralizing its salt form.

### EXAMPLES

The embodiments having been generally described, the following examples are given as particular embodiments of the disclosure and to demonstrate the practice and advantages thereof. It is understood that the examples are given by way of illustration and are not intended to limit the specification or the claims in any manner.

### Example 1

The properties of polysuccinimide as a DM were investigated. More specifically, the ability of polysuccinimide to prevent fluid loss was investigated via static fluid loss tests. All static fluid loss tests were performed in a fluid loss cell. The wt. % in the examples are based on the final weight of the solutions. For the static fluid loss tests, a porous 20μ (pore diameter) aloxite disc was used to simulate a permeable formation. The aloxite disc was placed in the bottom of the fluid loss cell, and the permeability of the disc was measured by passing 2% KCl fluid under pressure through the disc. The amount of filtrate was monitored as a function of time.

The permeability of the aloxite disc to a base gel was determined. The base gel was obtained as follows: 2000 mL of a KCl brine with a density of 8.43 pounds per gallon (ppg) and a pH of 6.53 was mixed with WG-11 gelling agent at a concentration of 25 pounds per 1,000 gallons. WG-11 gelling agent is a chemically modified, low-residue guar gelling agent used in aqueous fracturing fluids, and is commercially available from Halliburton Energy Services, Inc.

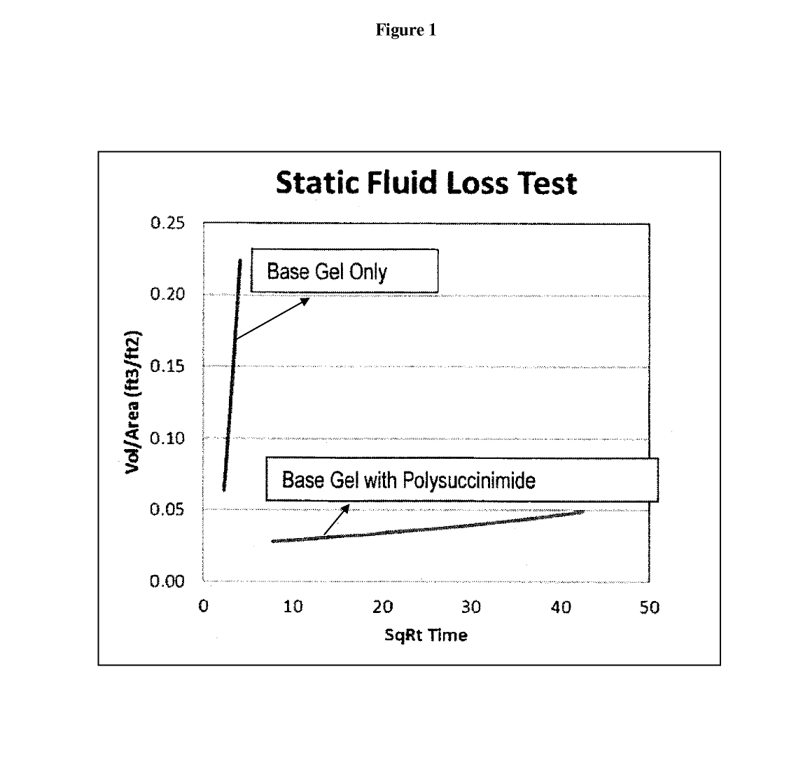

The base gel was tested in the fluid loss cell at a pressure of 100 psi, and the results are presented in FIG. 1.

To the base gel, polysuccinimide was added at a concentration of 120 pounds per 1,000 gallons. The polysuccinimide used in all examples was BAYPURE DSP polysuccinimide, which is commercially available from Bayer Chemicals. The base gel with polysuccinimide was further tested in the fluid loss cell at a pressure of 100 psi and the results are also presented in FIG. 1. In FIG. 1, the volume collected from the fluid loss cell normalized by the area of the aloxite disc is plotted as a function of the square root of time. In the case when the base gel alone was tested, the slope of the curve is very steep, indicating that the fluid in the test cell passed through the aloxite disc very quickly. The data points collected and the results calculated for the base gel curve from FIG. 1 are displayed in Table 1. When polysuccinimide was added to the base gel, there was very little fluid passing through the aloxite disc over an extended period of time (see FIG. 1), indicating the formation of an effective filtercake (i.e., diverter plug) by the polysuccinimide present in the gel.

Vₛₚ, designates the spurt loss which represents the amount of fluid collected at the beginning of the test, before the filtercake (i.e., diverter plug) forms on the porous aloxite disc and the flow of liquid equilibrates. Vₛₚ is expressed in gallons per square foot (gal/ft²). The larger the volume collected as a “spurt,” the longer it takes for the material tested to form a filtercake (i.e., diverter plug). The static fluid test also yields a fluid-loss coefficient value C_{w} (also referred to as the Wall-coefficient), which may be expressed in ft/min^{0.5}. C_{w} represents an alternate way of expressing the permeability of the filtercake (i.e., diverter plug). For the data collected for FIG. 1, the Vₛₚ was determined to be 0.194493 gal/ft². The fluid-loss coefficient C_{w} value was 0.00015 ft/min_{0.5}. The low C_{w} value indicates the formation of an effective filtercake (i.e., diverter plug) by the polysuccinimide present in the gel, which could provide excellent fluid loss control in a high permeability zone.

TABLE 1

| Elapsed Time | | Fluid Loss | Volume/Area | Volume/Area |
|---|---|---|---|---|
| [seconds] | √time | [mL] | [cm³/cm²] | [ft³/ft²] |
| 5 | 2.24 | 50 | 1.9501 | 0.0640 |
| 10 | 3.16 | 110 | 4.2903 | 0.1408 |
| 16 | 4.00 | 175 | 6.8255 | 0.2239 |

### Example 2

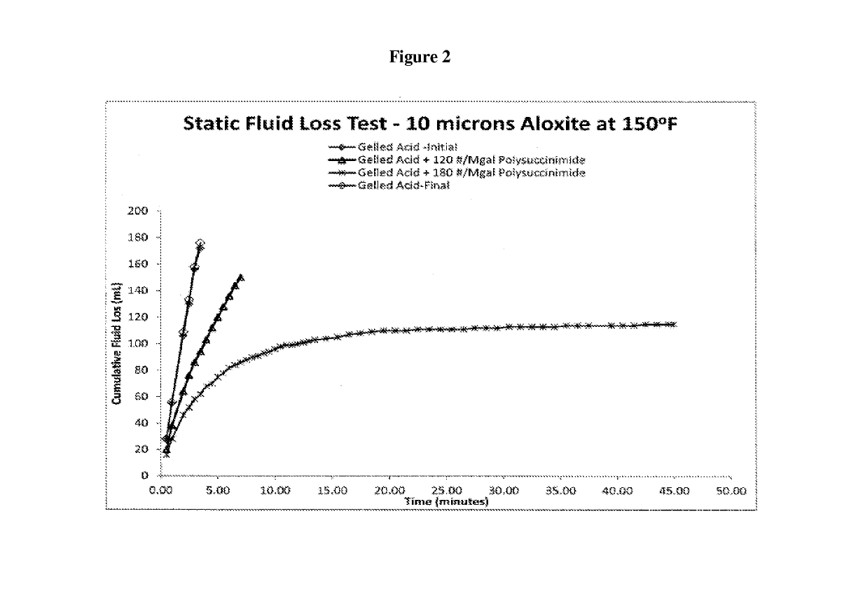

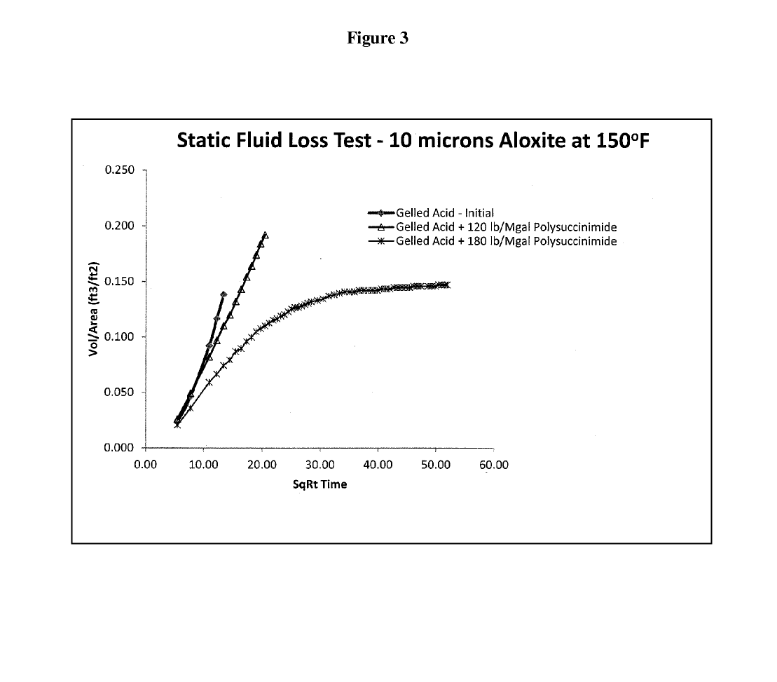

The properties of polysuccinimide as diverting material were investigated. More specifically, the ability of polysuccinimide to prevent fluid loss under acidic conditions was investigated via static fluid loss tests. All static fluid loss tests were performed as described in Example 1, unless otherwise specified. The aloxite disc used had a 10 micron pore diameter, and the permeability of the aloxite disc was determined to be about 1 Darcy. The tests were conducted at 150° F. A pressure of 50 psi was applied to the fluid loss cell. The base gel in this case was obtained by mixing 5% HCl with SGA-HT acid gelling agent at a concentration of 20 pounds per 1,000 gallons. SGA-HT acid gelling agent is a high-temperature synthetic copolymer gelling agent that can be used to gel most acid systems. SGA-HT acid gelling agent is commercially available from Halliburton Energy Services, Inc. The polysuccinimide was used at two different concentrations, 120 pounds per 1,000 gallons and 180 pounds per 1,000 gallons, and the data are displayed in FIG. 2 by plotting cumulative volume of filtrate collected as a function of time and in FIG. 3 by plotting normalized fluid loss volume as a function of square root of time. The “gelled acid—initial” curve in FIG. 2 and FIG. 3 corresponds to the tests conducted on the acidic base gel, with no polysuccinimide present in the gel.

The results demonstrate that polysuccinimide at a loading of 120 pounds per 1,000 gallons provides better fluid loss control than the gelled acid with no polysuccinimide. The overall results indicate that polysuccinimide can form an effective filtercake (i.e., diverter plug) under acidic conditions at the higher concentration loadings, i.e., 180 pounds per 1,000 gallons.

### Example 3

The properties of polysuccinimide as a diverting material were investigated. More specifically, the degradability of polysuccinimide in various environments was investigated. A first sample was prepared by suspending 0.5% by weight polysuccinimide in tap water at room temperature which was then stored over a month. After approximately one month the amount of polysuccinimide that has dissolved measured by filtration was about 20 to 40%. The filtrate containing the dissolved polysuccinimide was brown colored. A second sample was prepared by suspending polysuccinimide in 15% HCl. The second sample was kept in an oven at 150° F. for 48 h. A visual inspection of the second sample at the end of 48 h showed that the fluid remained colorless, indicating that the polysuccinimide did not dissolve in the acid, and is stable at low pH and elevated temperatures. The acidic environment (i.e., 15% HCl) improves the stability (e.g., decreases the solubility) of polysuccinimide, when compared to tap water.

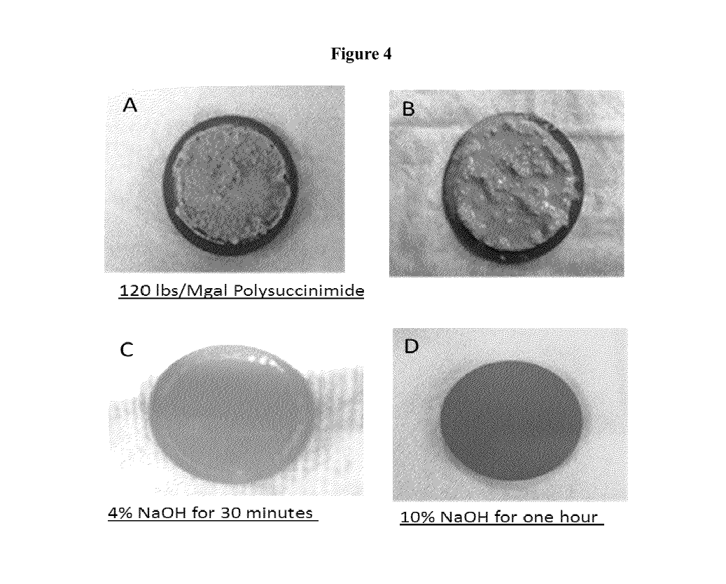

Aloxite discs subjected to the static fluid loss tests in Example 2 were removed from the fluid loss cell, and representative pictures of the filtercake buildup are shown in FIG. 4. FIG. 4A displays the polysuccinimide filtercake buildup on the aloxite disc at a loading of 120 pounds per 1,000 gallons, and FIG. 4B displays the polysuccinimide filtercake buildup on the aloxite disc at a loading of 180 pounds per 1,000 gallons. When the polysuccinimide loading was higher, the visual inspection revealed more filtercake buildup on the aloxite disc.

The aloxite disc subjected to the static fluid loss tests using 180 pounds per 1000 gallons in Example 2 were further treated with a 4% NaOH solution. Only enough NaOH solution for submerging the aloxite disc was used. The aloxite disc with the partially degraded filtercake buildup after a 30 min of treatment with a 4% NaOH solution is pictured in FIG. 4C. The NaOH treatment did not remove the entire filtercake, and traces of gel-like buildup are still visible on the aloxite disc. Because of the traces of orange color that is visble in FIG. 3b, the disc was again immersed in 10% NaOH and kept at 150° F. for a few hours. The picture of the treated disc is shown in FIG. 4D. The second treatment appeared to have removed all traces of color. The permeability of the cleaned up disc was measured under conditions identical to those used for fluid loss measurement. The results can be seen in FIG. 2 as ‘Gelled acid—Final’. It is clear that the permeabilities of the original disc and the treated disc are identical. This result clearly indicates that polysuccinimide filter cake can be removed with sodium hydroxide solution in a matter of few hours, which will reduce the waiting-on-filtercake removal time significantly compared to that without using a breaker chemical by using only water for removal. The results are also plotted FIG. 3 as filtrate volume per unit area as a function of square root of time (sec).

### Example 4

Polysuccinimide was also tested for its degradability in the presence of various amino alcohols. For these tests, the polysuccinimide was ground to a fine mesh with a particle size of about 270 mesh, and then 0.5 g of this solid was suspended in 10 mL water. The following alkanolamines were added to the suspension, to the noted concentrations: 4% triisopropanaolamine; 15% diethanolamine; 4% diethanolamine; 4% 3-amino-1,2-propanol. The tests were conducted at room temperature. In each of the four cases, the polysuccinimide immediately and completely dissolved upon addition of the alkanolamine to form clear dark red solutions, indicating that the alkanolamines are more efficient for the removal of polysuccinimide than NaOH. A control solution with 0.5 g of polysuccinimide suspended in 10 mL water was stored for over 1 month. At the end of the 1 month time period, about 20-40% of the polysuccinimide had dissolved in water. In another experiment, 0.5 grams of ground polysuccinimide was added to 50 ml of 1% solution of triethylene tetramine in water. Polysuccinimide dissolved in less than one minute to form a clear red solution. The result indicates that organic amines can function as degrading accelerators for polysuccinimide.

The following are additional enumerated embodiments of the concepts disclosed herein.

A first embodiment which is a method of servicing a wellbore in a subterranean formation comprising placing a composition comprising a carrier fluid and a degradable polymer into the subterranean formation wherein the degradable polymer comprises polyimide; allowing the degradable polymer to form a diverter plug at a first location in the wellbore or subterranean formation; diverting the flow of a wellbore servicing fluid to a second location in the wellbore or subterranean formation that is different than the first location; and removing all or a portion of the diverter plug by contacting the diverter plug with a degradation accelerator wherein the degradation accelerator comprises an amino alcohol, an amino alcohol precursor, an organic amine, an organic amine precursor or combinations thereof.

A second embodiment which is the method of the first embodiment wherein the degradable polymer comprises polyimide homopolymers, polyamido-imide, or polyesterimides.

A third embodiment which is the method of any of the first through second embodiments wherein the polyimide comprises polysuccinimide.

A fourth embodiment which is the method of any of the first through third embodiments wherein the polyimide further comprises a plasticizer.

A fifth embodiment which is the method of any of the first through fourth embodiments wherein the polyimide is in particulate form and has a size of from about 25 microns to about 5 mm.

A sixth embodiment which is the method of any of the first through fifth embodiments wherein the carrier fluid comprises an aqueous fluid and a suspending agent.

A seventh embodiment which is the method of the sixth embodiment wherein the aqueous fluid comprises sea water, freshwater, naturally-occurring and artificially-created brines containing organic and/or inorganic dissolved salts, liquids comprising water-miscible organic compounds, or combinations thereof.

An eighth embodiment which is the method of any of the first through seventh embodiments wherein the polyimide is present in the composition in an amount of from about 1 lbm/1000 gal to about 1000 lbm/1000 gal based on the total weight of the composition.

A ninth embodiment which is the method of any of the first through eighth embodiments wherein the suspending agent comprises colloidal materials, clays or viscosifying polymers.

A tenth embodiment which is the method of any of the first through ninth embodiments wherein the suspending agent is present in the composition in an amount of from about 0.01 wt. % to about 10 wt. % based on the total weight of the composition.

An eleventh embodiment which is the method of any of the first through tenth embodiments wherein the carrier fluid is a fracturing fluid or acidizing fluid.

A twelfth embodiment which is the method of any of the first through eleventh embodiments wherein the carrier fluid has a pH of less than about 7.

A thirteenth embodiment which is the method of any of the first through twelfth embodiments wherein the amino alcohol comprises include ethanolamine, N,N-dimethylethanolamine, triethanolamine, triisopropanolamine, 3-amino-1,2-propanol, diethanolamine, ethylene diamine, diethylene triamine, triethylene tetraamine, tetraethylene pentamine, or combinations thereof.

A fourteenth embodiment which is the method of any of the first through thirteenth embodiments wherein the degradation accelerator is present in an amount of from about 10 mole. % to about 110 mole % based on the number of moles of monomer present in the degradable polymer.

A fifteenth embodiment which is a wellbore servicing fluid comprising polysuccinimide wherein the wellbores servicing fluid has a pH of less than about 7.

A sixteenth embodiment which the fluid of the fifteenth embodiment further comprising an amino alcohol, amino alcohol precursor, an organic amine, an organic amine precursor or combinations thereof.

A seventeenth embodiment which is the fluid of the fifteenth embodiment further comprising a suspending agent.

An eighteenth embodiment which is a method of servicing a wellbore in a subterranean formation comprising placing a first quantity of a fracturing fluid, an acidizing fluid, or both at a first location in the subterranean formation; placing a polyimide-laden fluid at the first location in the subterranean formation to form a diverter plug; placing a second quantity of fracturing fluid, acidizing fluid, or both at a second location in the subterranean formation, wherein the diverter plug diverts the second quantity from the first location to the second location; and removing all or a portion of the diverter plug by contacting the diverter plug with a degradation accelerator wherein the degradation accelerator comprises an amino alcohol, an amino alcohol precursor or combinations thereof.

A nineteenth embodiment which is the method of the eighteenth embodiment further comprising adding polyimide to a portion of the first quantity of the fracturing fluid, the acidizing fluid, or both to form the polyimide-laden fluid.

A twentieth embodiment which is a method of servicing a wellbore in a subterranean formation comprising placing a composition comprising a carrier fluid and a degradable polymer into the subterranean formation wherein the degradable polymer comprises a polyimide, and a phase transfer catalyst; allowing the degradable polymer to form a diverter plug at a first location in the wellbore or subterranean formation; diverting the flow of a wellbore servicing fluid to a second location in the wellbore or subterranean formation that is different than the first location; and removing all or a portion of the diverter plug by contacting the diverter plug with a degradation accelerator wherein the degradation accelerator comprises an inorganic base or base precursor.

A twenty-first embodiment which is a method of the twentieth embodiment wherein the phase transfer catalyst comprises a quaternary ammonium salt, a quaternary phosphonium salt, a quaternary arsonium salt or alkylpyridinium salt or combinations thereof.

A twenty-second embodiment which is the method of any of the twentieth through twenty-first embodiments wherein the base is sodium hydroxide.

A twenty-third embodiment which is a method of servicing a wellbore in a subterranean formation comprising: placing a first quantity of a fracturing fluid, an acidizing fluid, or both at a first location in the subterranean formation; placing a polyimide-laden fluid comprising an amino alcohol, an amino alcohol precursor, an organic amine, an organic amine precursor or any combination thereof at the first location in the subterranean formation to form a diverter plug; placing a second quantity of an acidic wellbore servicing fluid at a second location in the subterranean formation, wherein the diverter plug diverts the second quantity from the first location to the second location; and removing all or a portion of the diverter plug by placing the well on production and allowing the flow back fluid comprising a spent acidic wellbore servicing fluid.

While embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R_{L}, and an upper limit, R_{U}, is disclosed, any number falling within the range is specifically disclosed. In particular, the following numbers within the range are specifically disclosed: R=R_{L}+k*(R_{U}−R_{L}), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an embodiment of the present invention. Thus, the claims are a further description and are an addition to the embodiments of the present invention. The discussion of a reference in the Description of Related Art is not an admission that it is prior art to the present invention, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A method of servicing a wellbore in a subterranean formation comprising:
placing a composition comprising a carrier fluid and a degradable polymer into the subterranean formation wherein the degradable polymer comprises polyimide;
allowing the degradable polymer to form a diverter plug at a first location in the wellbore or subterranean formation;
diverting the flow of a wellbore servicing fluid to a second location in the wellbore or subterranean formation that is different than the first location; and
removing all or a portion of the diverter plug by contacting the diverter plug with a degradation accelerator wherein the degradation accelerator comprises an amino alcohol, an amino alcohol precursor, an organic amine, an organic amine precursor or combinations thereof.

2. The method of claim 1 wherein the degradable polymer comprises polyimide homopolymers, polyamido-imide, or polyesterimides.

3. The method of claim 1 wherein the polyimide comprises polysuccinimide.

4. The method of claim 1 wherein the polyimide further comprises a plasticizer.

5. The method of claim 1 wherein the polyimide is in particulate form and has a size of from about 25 microns to about 5 mm.

6. The method of claim 1 wherein the carrier fluid comprises an aqueous fluid and a suspending agent.

7. The method of claim 6 wherein the aqueous fluid comprises sea water, freshwater, naturally-occurring and artificially-created brines containing organic and/or inorganic dissolved salts, liquids comprising water-miscible organic compounds, or combinations thereof.

8. The method of claim 1 wherein the polyimide is present in the composition in an amount of from about 1 lbm/1000 gal to about 1000 lbm/1000 gal based on the total weight of the composition.

9. The method of claim 6 wherein the suspending agent comprises colloidal materials, clays or viscosifying polymers.

10. The method of claim 6 wherein the suspending agent is present in the composition in an amount of from about 0.01 wt. % to about 10 wt. % based on the total weight of the composition.

11. The method of claim 1 wherein the carrier fluid is a fracturing fluid or acidizing fluid.

12. The method of claim 11 wherein the carrier fluid has a pH of less than about 7.

13. The method of claim 1 wherein the amino alcohol comprises include ethanolamine, N,N-dimethylethanolamine, triethanolamine, triisopropanolamine, 3-amino-1,2-propanol, diethanolamine, ethylene diamine, diethylene triamine, triethylene tetraamine, tetraethylene pentamine, or combinations thereof.

14. The method of claim 1 wherein the degradation accelerator is present in an amount of from about 10 mole. % to about 110 mole % based on the number of moles of monomer present in the degradable polymer.

15. A wellbore servicing fluid comprising polysuccinimide wherein the wellbores servicing fluid has a pH of less than about 7.

16. The fluid of claim 15 further comprising an amino alcohol, amino alcohol precursor, an organic amine, an organic amine precursor or combinations thereof.

17. The fluid of claim 15 further comprising a suspending agent.

18. A method of servicing a wellbore in a subterranean formation comprising:
placing a first quantity of a fracturing fluid, an acidizing fluid, or both at a first location in the subterranean formation;
placing a polyimide-laden fluid at the first location in the subterranean formation to form a diverter plug;
placing a second quantity of fracturing fluid, acidizing fluid, or both at a second location in the subterranean formation, wherein the diverter plug diverts the second quantity from the first location to the second location; and
removing all or a portion of the diverter plug by contacting the diverter plug with a degradation accelerator wherein the degradation accelerator comprises an amino alcohol, an amino alcohol precursor or combinations thereof.

19. The method of claim 18 further comprising adding polyimide to a portion of the first quantity of the fracturing fluid, the acidizing fluid, or both to form the polyimide-laden fluid.

20. A method of servicing a wellbore in a subterranean formation comprising:
placing a composition comprising a carrier fluid and a degradable polymer into the subterranean formation wherein the degradable polymer comprises a polyimide, and a phase transfer catalyst;
allowing the degradable polymer to form a diverter plug at a first location in the wellbore or subterranean formation;
diverting the flow of a wellbore servicing fluid to a second location in the wellbore or subterranean formation that is different than the first location; and
removing all or a portion of the diverter plug by contacting the diverter plug with a degradation accelerator wherein the degradation accelerator comprises an inorganic base or base precursor.

21. The method of claim 20 wherein the phase transfer catalyst comprises a quaternary ammonium salt, a quaternary phosphonium salt, a quaternary arsonium salt or alkylpyridinium salt or combinations thereof.

22. The method of claim 20 wherein the base is sodium hydroxide.

23. A method of servicing a wellbore in a subterranean formation comprising:
placing a first quantity of a fracturing fluid, an acidizing fluid, or both at a first location in the subterranean formation;
placing a polyimide-laden fluid comprising an amino alcohol, an amino alcohol precursor, an organic amine, an organic amine precursor or any combination thereof at the first location in the subterranean formation to form a diverter plug;
placing a second quantity of an acidic wellbore servicing fluid at a second location in the subterranean formation, wherein the diverter plug diverts the second quantity from the first location to the second location; and
removing all or a portion of the diverter plug by placing the well on production and allowing the flow back fluid comprising a spent acidic wellbore servicing fluid.
